(19) United States
(12) Patent Application Publication
(10) Pub. No.: US 2006/0102034 A1
(43) Pub. Date: May 18, 2006

(54) Washing apparatus for printing and/or coating mechanisms in a processing machine

(75) Inventors: Rainer Gebhard Dipl-Ing, Offenbach (DE); Lothar Kuhlmeyer Ing, Darmstadt (DE); Joachim Olek, Obertshausen (DE); Guido Reschke Dipl-Ing, Hunfelden-Ohren (DE); Jurgen Scholzing Dipl-Ing, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach (DE)

(21) Appl. No.: 10/545,751

(22) PCT Filed: Feb. 6, 2004
(86) PCT No.: PCT/EP04/01089

§ 371 Date: Oct. 4, 2005

(30) Foreign Application Priority Data
Feb. 15, 2003 (DE) G 203 02 462.1

(51) Int. Cl. B41F 35/00

(52) U.S. Cl. 101/425

(57) ABSTRACT

A washing apparatus for printing and/or coating mechanisms in a processing machine is provided. The washing apparatus permits a stable disposal of soiled cleaning fluid and noticeably reducing the disposal expense in at least one printing/coating mechanism. To that end, between at least one washing apparatus 7.1, 7.2, 7.3 and a return line feeding into a holding container, there is a piston pump on the line side coupled to a machine controller.

### FIELD OF THE INVENTION

The invention concerns a washing apparatus for printing and/or coating mechanisms in a processing machine. Such a washing apparatus can be used, in particular, in a printing or coating machine, including a varnishing machine, or in combinations of printing and varnishing mechanisms of a processing machine.

### BACKGROUND OF THE INVENTION

A washing apparatus for cleaning a rubber blanket cylinder in an offset printing machine is known from DE 91 15 948.2 U1. The washing apparatus is connected to a supply line for the cleaning fluid and a return line with subsequently inserted holding containers for soiled cleaning fluid. The soiled cleaning fluid flows, with the effect of gravity, to a holding container. A filter line leading to a filter device, in which a pump is located, comes after the holding container. The filter line continues from the filter device to a supply container coupled with the supply line. The holding container has a level switch, which activates the filter pump, and by means of the filter pump, the soiled cleaning fluid is driven through the filter device.

The disadvantage hereby is that the removal of the soiled cleaning fluid from the washing apparatus to the holding container takes place on the path by means of gravity and the danger exists that the return line may clog up. The elimination of the clogging is expensive, since frequently the return line must be cleaned and possibly dismantled.

From U.S. Pat. No. 5,241,908 A, a cleaning apparatus is known, in which the washing housing bottom is cleaned by means of compressed air and then, the impurities are suctioned from the housing by negative pressure and expelled by means of an ejector located on the housing, via a return line. The disadvantage hereby is that the negative pressure is frequently not enough for a stable cleaning and there is a high consumption of air. A possible use of cleaning fluid in such an apparatus appears to be unfavorable.

### SUMMARY OF THE INVENTION

An object of the invention is to create a washing apparatus of the type described in the beginning, which avoids the aforementioned disadvantages, which at least permits a stable disposal of soiled cleaning fluid in a printing/coating mechanism and noticeably reduces the disposal or cleaning expense.

The problem is solved by the embodiment features of claim 1. Refinements can be deduced from the subclaims.

A first advantage is found therein that, in a processing machine with, preferably, several printing and/or coating mechanisms between the several washing devices preferably located there and a preferably central holding container in a joint return line system, there is at least one piston pump, preferably, one axial piston pump. This piston pump conveys the soiled cleaning fluid to at least one holding container.

A piston pump is correlated with each individual printing/coating mechanism. Alternatively, a piston pump is correlated with printing and/or coating mechanisms, brought together in groups, preferably adjacent to one another.

A second advantage is to be found in the fact that the washing device, for example, brush washing devices, common in processing machines, can be coupled, on the return side on this return line system, which is coupled with preferably one axial piston pump. These are, in particular, inking mechanism-roller-washing devices, rubber blanket cylinder-washing devices or form cylinder-washing devices, printing cylinder-washing devices, and washing devices for metering systems, including, chamber/doctor application roller systems. Such washing devices have at least one return line on the housing, which can be placed directly on the housing or can be coupled with a housing discharge. Furthermore, collecting vats or drip pans, provided with a discharge, are also linked to the return line, on the return side.

Alternatively, the piston pump can be placed directly on the return (discharge) of the washing apparatus housing, the collecting vat, or the drip pan. Preferably, the path of the return line is designed so as to be short between the washing apparatus or the collecting vat/drip vat.

The washing apparatuses have at least in common that they have at least one supply line for one cleaning fluid.

The washing apparatuses feed the cleaning fluid, which is soiled, for example, by dye or varnish particles, paper dust, powder, etc., into at least one common return line, coupled with an axial piston pump. Preferably one parallel arrangement of the return lines can be implemented in printing/coating mechanisms brought together in groups, with preferably one axial piston pump. Every return line is coupled with the correlated piston pump, either individually, or joined beforehand to form one common return line.

It is also advantageous that cloggings are avoidable with this return line system and the piston pump that is used, and this is true even with small amounts of cleaning fluid or with cleaning fluids which do not flow so well. Thus, a stable disposal of soiled cleaning fluid is guaranteed in every printing/coating mechanism. Furthermore, in these embodiments, the expense for the conveyance through the line and the disposal expense for the soiled cleaning fluid are reduced.

The invention is to be explained in more detail on the basis of one embodiment. The figures show the following schematically:

### BRIEF DESCRIPTION OF THE DRAWINGS

FIG. 1 is a printing machine with several printing mechanisms and a coating mechanism;

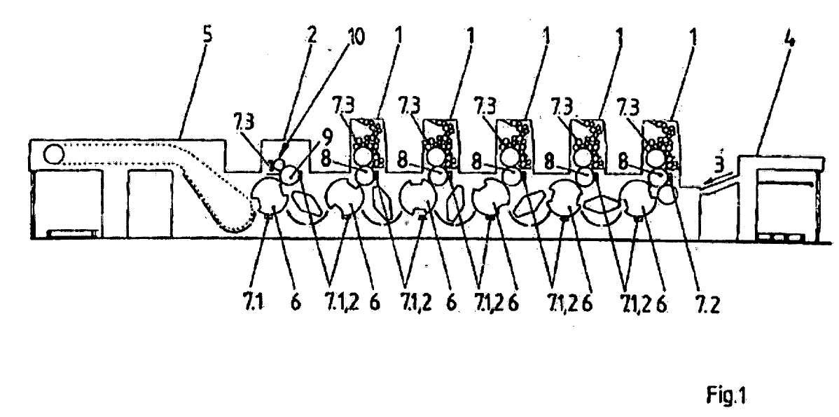

FIG. 2 is an arrangement of washing apparatuses in a printing/coating mechanism.

### DETAILED DESCRIPTION OF THE INVENTION

A processing machine is constructed as a sheet-fed rotary printing machine, which has a plurality of printing mechanisms 1. In the conveyance direction 3 of the material to be printed, a coating mechanism 2, preferably, a varnishing mechanism, is also inserted after the last printing mechanism 1. In a refinement, several coating mechanisms 2 are placed before or after the printing mechanisms 1. Alternatively, such a processing machine can be constructed exclusively from coating mechanisms 2, for example, varnishing and/or flexo mechanisms.

Every printing mechanism 1 has a plate cylinder with a dyeing mechanism, perhaps with a moistening mechanism, a rubber blanket cylinder 8, and a printing cylinder 6 as a sheet conveying cylinder. At least one transfer cylinder follows the printing cylinder 6 in the conveyance direction 3 of the sheet-shaped material to be printed. The printing machine also has an input 4 with a supply table and an output device 5 inserted after the coating mechanism 2. The coating mechanism 2 also has a sheet-conveying printing cylinder 6 and a form cylinder 9, coupled with a metering system 10.

Every printing and coating mechanism 1, 2 has at least one washing apparatus 7, coupled with at least one supply line for a cleaning fluid. Cloth or brush washing apparatuses, seated in a housing, but also doctor washing apparatuses with a collecting vat (and return), for example, DE 200 02 333 U1, and metering systems, constructed with a return, for example, chamber doctors, can be used as washing apparatuses 7.

In the example under consideration, the washing apparatus 7 in every printing mechanism 1 comprises a dyeing mechanism-roller washing apparatus 7.3, which is constructed as a doctor device with a collecting vat and a return, a rubber blanket cylinder washing apparatus 7.2, which is constructed as a cloth washing apparatus seated in a housing, and a printing cylinder-washing apparatus, which is constructed as a brush washing apparatus seated in a housing.

The present embodiment also comprises the washing apparatus 7 in the coating mechanism 2, a metering system washing apparatus 7.3, which, for example, is constructed as a chamber doctor system with a doctor roller and a return, a form cylinder washing apparatus 7.2, which is constructed as a brush washing apparatus seated in a housing, and a printing cylinder-washing apparatus 7.1, which is also constructed as a brush washing apparatus seated in a housing.

Each of the washing apparatuses 7.1-7.3 has at least one supply line for a cleaning fluid, alternatively, for several cleaning fluids. The supply lines discharge into the housing (washing apparatuses 7.1, 7.2) or are coupled with the metering system 10 (washing apparatus 7.3). The combined arrangement of the washing apparatuses 7.1-7.3 is not limited to this embodiment. Rather, individual washing apparatuses 7.1 and/or 7.2 and/or 7.3, or two of the latter, can be placed in the printing/coating mechanisms 1, 2.

In each printing mechanism 1 or each coating mechanism 2, the respective washing device 7 (or 7.1, 7.2, 7.3) is coupled with a return line 11, 22 leading to a holding container 17. A piston pump 12 is arranged on the line side between at least one washing device 7 and the holding container 17. The piston pump 12 operates according to the displacement principle, preferably with a fixed displacement volume.

Preferably, the piston pump 12 is an axial piston pump (pump cylinder), into which a first return branch 11 feeds the soiled cleaning fluid from the return line 11, 22, via a first valve 13 (opening element/closing element).

The piston pump 12 is also coupled with pneumatically loaded supply lines 21, which are coupled with a control valve 14. The control valve 14 is coupled with an air supply 15, preferably the compressed air supply of the processing machine. Preferably, the control valve 14 is also coupled, with a machine controller 16, directly to the printing or coating mechanism 1,2 and/or a central controller of the processing machine. Preferably, the machine controller 16 is coupled by a line (control line 19) with each of the washing apparatuses 7.1-7.3 used in the printing/coating mechanism.

The actuation of the piston pump 12 is not limited to the pneumatic mode of operation. Rather, electrical control of the piston pump 12, preferably an axial piston pump, can also be implemented. The piston pump 12 in this case is directly coupled, with the machine control 16. Alternatively, a hydraulic or other mechanical mode of operation can also be implemented.

From the piston pump 12, preferably an axial piston pump, a second return branch 22 leads to the holding container 17 and is discharged there. To this end, the piston pump 12 has a second valve 13 (opening element/closing element) which, in connection with the activated piston of the piston pump 12, transports the soiled cleaning fluid on to the holding container 17. The holding container 17 is located on the processing machine (stationary or movable) or centrally, in a pressure chamber. With several processing machines, an interlinkage to a central processing or disposal unit for soiled cleaning fluid can also be implemented.

The holding container 17 is not limited to one vessel. Rather, several holding containers 17, which interconnected or interchangeable (alternating operation), can be arranged for the storage of variously soiled cleaning fluids. Thus, for example, one holding container 17 is only for the collection of a mixture of soiled cleaning fluid and UV varnish; another holding container 17 can be used for collecting a mixture of soiled cleaning fluid and dispersion varnish; or another holding container 17, for collecting a mixture of soiled cleaning fluid and offset ink.

In one refinement, the holding container 17 is connected on the line side to a downstream processing unit 20 operating, for example, according to the sedimentation principle or according to the principle of vacuum distillation.

A filling level gauge 18 for level monitoring is preferably arranged on holding container 17. Preferably, a control signal is produced when a prespecified filling level of the filling level gauge 18 is reached. To this end, the filling level gauge 18 is preferably coupled, by means of a control line 19, with the machine control 16. The control signal is preferably sent to the machine control 16 by means of an optical or acoustical display or the switching off of the active washing apparatus 7.

In a preferred refinement, the filling level gauge 18 records two filling levels in the holding container 17. First the maximum filling level, for which a first electrical signal can be transmitted to the machine control 16 when it is reached and then relayed to the pertinent washing apparatus 7. Secondly, a lower filling level, which lies under the maximum filling level, for which a second electrical signal can be transmitted to an optical or acoustical or other display device when it is reached. Alternatively, a continuous filling level measurement can be implemented, for example, by means of a probe for online recording of the filling level to detach theoretical/actual value recording that is coupled with the machine control.

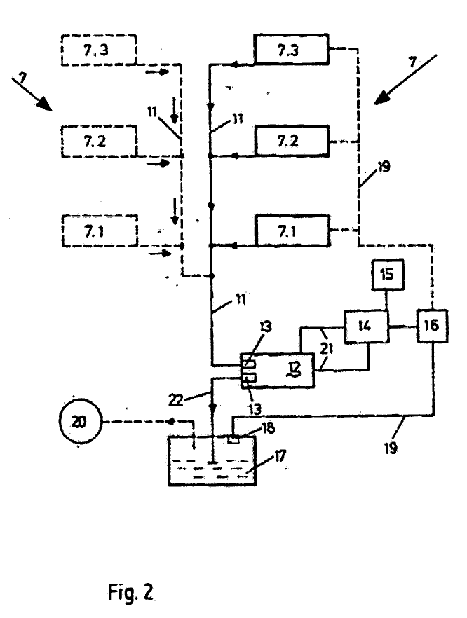

FIG. 2 shows the arrangement of the washing apparatuses 7 (7.1, 7.2, 7.3) with a piston pump 12 and one holding container 17 per printing/coating mechanism 1, 2 in solid lines. The connection of another washing apparatus 7 (7.1, 7.2, 7.3) for another, preferably adjacent printing/coating mechanism 1, 2 is also shown in broken lines. Thus, a grouped connection of the first return branches 11 with a piston pump 12 can be implemented.

The construction of the washing apparatus is not limited to the embodiment under consideration.

Alternatively, there is a piston pump 12 between each washing apparatus 7; 7.1, 7.2, 7.3 and each return line 11, 12. The piston pumps 12 are coupled with the machine control 16. The return lines 11, 22 are connected with at least one downstream collecting line, which feeds into a holding container 17. Several return lines 11, 22 feed the soiled cleaning fluid into the collecting line or connecting lines. When using different cleaning fluids (or dyes/varnishes), or cleaning fluids which are incompatible with one another, there can be two collecting lines, one collecting line for conventional cleaning fluid and one collecting line for UV cleaning fluid. These collecting lines then feed into different holding containers 17, in order to avoid any mixing.

In another embodiment, several return lines 11, 12 can be connected on the line side, and a (single) piston pump 12 coupled with the machine controller 16 is integrated into the coupled return lines 11, 22. The return lines 11, 22 are connected, on the line side, to at least one downstream collecting line. The collecting lines feed into at least one holding container 17. Depending on the need, several collecting lines also feed into separate holding containers 17.

In the washing apparatuses 7 (7.1, 7.2, 7.3) used in the printing/coating mechanism 1,2, the soiled cleaning fluid is fed into the first return branch 11. The type of feeding (for example, by means of gravity, by means of compressed air, or fluid assistance) is not critical. The first return branch 11 feeds the soiled cleaning fluid into the pressure chamber of the piston pump 12, constructed here as an axial piston pump, via the opened first valve 13 (inlet valve). The second valve 13 (outlet valve) is closed at this time. The piston of the piston pump 12 is activated in the axis direction via the machine control 16 and expels the pressurized soiled cleaning fluid from the pressure chamber via the second return branch 22 to the holding container 17. To this end, the second valve 13 (outlet valve) is opened in the meantime, and the first valve 13 (inlet valve) is closed. The piston pump 12 can be operated periodically in pulse operation via the machine controller 16. Piston dampening can be implemented by waste air throttling on the piston pump 12. The pressure applied in the pressure chamber can be adjusted, for example, to take account of the type of soiled cleaning fluid, the number of printing/coating mechanisms 1, 2, or the length of the return line 11, 22.

After the washing process ends or before the cleaning fluid is changed, the holding container 17 is completely emptied. Thus, separate disposal or reprocessing can be implemented.

1-10. (canceled)

11. A washing apparatus for printing and/or coating mechanisms in a processing machine with a holding container for collecting soiled cleaning fluid, comprising:
a piston pump connected to at least one washing device in the processing machine;
a return line connecting the piston pump to the holding container for feeding soiled cleaning fluid from the piston pump into the holding container, the piston pump being coupled to a machine controller of the processing machine.

12. A washing apparatus according to claim 11, wherein the piston pump is an axial piston pump.

13. A washing apparatus according to claim 11, wherein the return line has a first return branch that leads from the at least washing device to the piston pump and has a second return branch that leads from the piston pump to the holding container.

14. A washing apparatus according to claim 11, wherein the piston pump is controlled electrically by the machine controller.

15. A washing apparatus according to claim 11, wherein the piston pump is controlled pneumatically.

16. A washing apparatus according to claim 15, further including a control valve for controlling supply of compressed air to the piston pump, the control valve being connected by switching circuitry to the machine controller.

17. A washing apparatus according to claim 11, further including a processing unit disposed downstream from the holding container.

18. A washing apparatus according to claim 11, wherein the piston pump is coupled on to washing devices of multiple printing and coating mechanisms.

19. A washing apparatus according to claim 11, including multiple piston pumps and return lines, wherein each piston pump is disposed between a corresponding one of multiple washing devices of the processing machine and a return line and coupled by switching circuitry to the machine controller, the return lines connected to at least one collecting line fed into the holding container.

20. A washing machine according to claim 11, wherein processing machine has multiple washing devices connected together to the piston pump.
